(19) United States
(12) Patent Application Publication
(10) Pub. No.: US 2015/0120199 A1
(43) Pub. Date: Apr. 30, 2015

(54) Multiple Domain Processing For Combining Reservoir Models and Seismic Data

(71) Applicant: Matthew S. Casey, Houston, TX (US)

(72) Inventor: Matthew S. Casey, Houston, TX (US)

(21) Appl. No.: 14/461,193

(22) Filed: Aug. 15, 2014

Related U.S. Application Data
(60) Provisional application No. 61/898,256, filed on Oct. 31, 2013.

(51) Int. Cl. G01V 1/32; G01V 1/30

(52) U.S. Cl. CPC G01V 1/32; G01V 1/306
USPC 702/14

(57) ABSTRACT

Method for using a non-stationary, multi-scale domain transformation to combine multiple geophysical data sources, for example seismic data and well log data, into one coherent reservoir model. The seismic data are inverted (71) to obtain one or more geophysical properties which are converted using petrophysical relationships to a subsurface model of a reservoir property such as porosity or shale volume fraction. The well log data are used to generate a geostatistical forward model (72) of the reservoir property. Both models of the reservoir property are transformed to a joint space/scale domain, of order >1, where processing is applied (73) to merge the models into a coherent way into a single model before inverse transforming back to the space domain (74). The transform is a non-stationary multi-scale transform such as a wavelet, ridgelet, or curvelet transform. The processing may be by, for example, information theory or convex combination.

### CROSS-REFERENCE TO RELATED APPLICATION

This application claims the benefit of U.S. Provisional Patent Application 61/898,256 filed Oct. 31, 2013 entitled MULTIPLE DOMAIN PROCESSING FOR COMBINING GEOSTATISTICAL MODELS AND SEISMIC DATA, the entirety of which is incorporated by reference herein.

### FIELD OF INVENTION

This disclosure relates generally to the field of geophysical prospecting and, more particularly, to the field of integrating well log and seismic data into a subsurface reservoir model.

### BACKGROUND

Most methods of modeling reservoirs in the subsurface are limited to a certain subset of scales or are stationary. Typically, both are common in practice (Isaaks 1989 and Journel 1992). Some of the more common methods involve using geostatistical techniques that were invented for the mining industry and explicitly assume stationarity. The geostatistical techniques that involve using a variogram and kriging interpolation explicitly define a single correlation length scale (i.e., data sets being simulated are correlated against each other over a specified spatial length) and assume that it does not change in the model space (stationarity assumption). Sometimes they are used in a compound manner or spatially controlled by another input in the spatial domain. However, even the most sophisticated applications of geostatistical methods do not deal directly in both the scale and space domain, and with non-stationarity. There is a class of methods know as Multiple Point Statistical (MPS) simulation that process data in the spatial domain and at a set of multiple resolutions that is called a multigrid. These methods also handle non-stationarity as a post-processing step (Strebelle 2002 and Zhang 2006). MPS does not however have a formal mathematical representation over both the scale and space domains simultaneously. The advantage of having a formal joint representation over both domains is the resultant methods can be guaranteed to have some desirable qualities such as speed, scalability, and exactness of the solutions. It enables the modeler to put certain frequencies of variation exactly where they want it. Thus, it is conceptually more intuitive than using constructive and destructive interference of globally periodic signals to accomplish the same task as in Calvert et al. 2001 and Yao et al. 2004.

There are two industry standard methods in reservoir modeling for incorporating seismic data and wireline logging information into one coherent model: Geostatistical Inversion (GI) and Spectral Component Reservoir Analysis (SCRA). There is a fundamental difference between the two. GI involves a local optimization on a trace-by-trace basis to find a suitable match with the inverted seismic data in the space domain (FIG. 1). SCRA on the other hand uses a global replacement of information with the frequency domain to ensure a match with the band-limited seismic data (FIG. 2). Beyond these fundamental differences, the pre- and post-processing steps needed are also slightly different (FIG. 1 and FIG. 2).

### Geostatistical Inversion

Seismic inversion is a common method used in reservoir modeling to incorporate seismic data and wireline logging information into one coherent model. The physics of elastic wave propagation are used to invert seismic data into property models of acoustic or elastic impedance (Connolly 1999 and Whitcombe 2002). These inverted volumes are inherently spectrally band-limited due to the recording frequencies of the original seismic data. Through the use of petrophysical relationships, the impedance volumes can be transformed into a petrophysical property volume such as porosity or shale volume fraction.

Geostatistical Inversion involves using a seismically inverted impedance data set as an input to a second optimization procedure that minimizes the misfit between it and a geostatistical simulation of impedance. This geostatistical inversion uses forward modeling methods such as Sequential Gaussian Simulation (SGS) (Isaaks 1990, and Verly 1991) that stochastically simulates acoustic impedance based on well log properties as hard data inputs and a predefined model of continuity called a variogram (Isaaks 1989 and 1990). Each xy map location that corresponds to a seismic trace is stochastically generated in a random path (Bortoli et al. 1992, and Haas and Dubrule 1994).

The next step is to convolve the stochastically simulated acoustic impedance with a representative wavelet extracted from the seismic data. This results in stochastically modeled reflectivity data that can be directly compared to the original seismic data. This method always honors hard well data and minimizes the misfit between the modeled data and the seismic inversion data by choosing the best matching modeled trace. Typically, the geocellular grid where SGS is performed is of higher resolution than the seismic data. This is due to the well log data being finely sampled as compared to the seismic data. Therefore, geostatistical inversion provides a higher resolution yet uncertain solution. Many realizations may fit both the SGS parameterizations, including the hard well data, and minimize the misfit from the seismic data (Haas and Dubrule 1994). Finally, a petrophysical transformation of the new impedance data is performed to get a petrophysical property such as porosity or shale volume. FIG. 1 shows basic steps in geostatistical inversion. FIG. 3 illustrates the method in more detail.

Seismic Conditioning of Geologic Models with Spectral Component Reservoir Analysis

Spectral Component Reservoir Analysis (SCRA) is an alternative way to condition a reservoir model to seismic data (Calvert 2001, and Yao 2004). In contrast to geostatistical inversion, SCRA (see FIG. 2) starts with a seismic data set, inverts for impedance and applies the petrophysical transformation to get a spectrally band limited petrophysical property volume of either porosity or shale volume. In the SCRA workflow another petrophysical property volume of the same type is generated with the well logs and SGS (Isaaks 1990 and Verly 1991) that contains a broader spectral bandwidth. These two volumes are then merged in the frequency domain by band pass filtering of the data and combining appropriate pieces together in the frequency domain. Then the frequency domain representation is transformed back to the space domain for the final merged volume (Calvert 2001, and Yao 2004). FIG. 4 illustrates the SCRA method in more detail than FIG. 2.

### SUMMARY

In one embodiment, the invention is a method for integrating well log and seismic data into a single subsurface reservoir model, comprising:

(a) obtaining seismic data and well log data from a subsurface region;

(b) inverting the seismic data and applying a petrophysical transformation to generate a subsurface model of a reservoir property (see step 71 in FIG. 7);

(c) generating a reservoir model (e.g., a geostatistical forward model) of the reservoir property using the well log data (step 72);

(d) transforming the reservoir property model from inverting seismic data and the reservoir property model from reservoir modeling (e.g., the geostatistical forward modeling) with well log data, to a joint domain, of order >1;

(e) processing the transformed models in the joint domain to coherently combine them into one coherent reservoir model (step 73); and (

f) inverse transforming to obtain a reservoir model in space domain (step 74); wherein (b)-(f) are performed using a computer.

### BRIEF DESCRIPTION OF THE DRAWINGS

The present invention will be better understood by referring to the following detailed description and the attached drawings in which:

FIG. 1 is a flow chart showing basic steps in performing Geostatistical Inversion;

FIG. 2 is a flow chart showing basic steps in performance Spectral Component Reservoir Analysis;

FIG. 3 is a flow chart illustrating Geostatistical Inversion in more detail;

FIG. 4 is a flow chart illustrating Spectral Component Reservoir Analysis in more detail;

FIG. 5 is a flow chart illustrating Bortoli's method of spatial processing;

FIG. 6 is a flow chart illustrating Calvert's method of frequency domain processing;

FIG. 7 is a flow chart illustrating how processing in the wavelet domain may be performed in the present invention using a heuristic method based on information theory;

FIG. 8 is a flow chart showing the method of FIG. 7 in more detail;

FIG. 9 is a flow chart illustrating how processing in the wavelet domain may be performed in the present invention using convex combination with spatially co-located weighting coefficients;

FIG. 10 is a flow chart showing the method of FIG. 9 in more detail;

FIG. 11 is a flow chart illustrating how processing in the curvelet domain may be performed in the present invention using a heuristic method based on information theory;

FIG. 12 is a flow chart showing the method of FIG. 11 in more detail;

FIG. 13 is a flow chart illustrating how processing in the curvelet domain may be performed in the present invention using convex combination with spatially co-located weighting coefficients;

FIG. 14 is a flow chart showing the method of FIG. 13 in more detail;

FIG. 15 is a flow chart illustrating how processing in the curvelet domain may be performed in the present invention using a user-defined method; and

FIG. 16 is a flow chart showing the method of FIG. 15 in more detail.

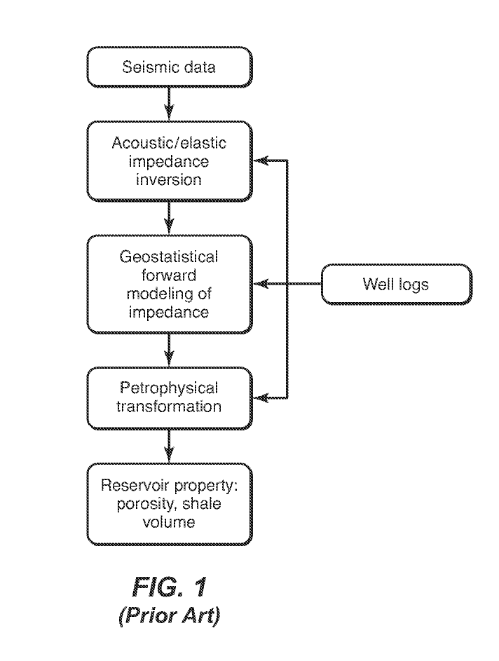

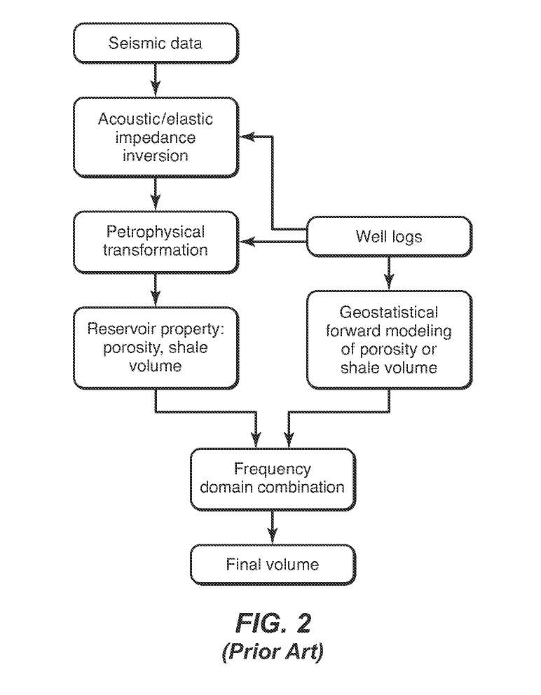

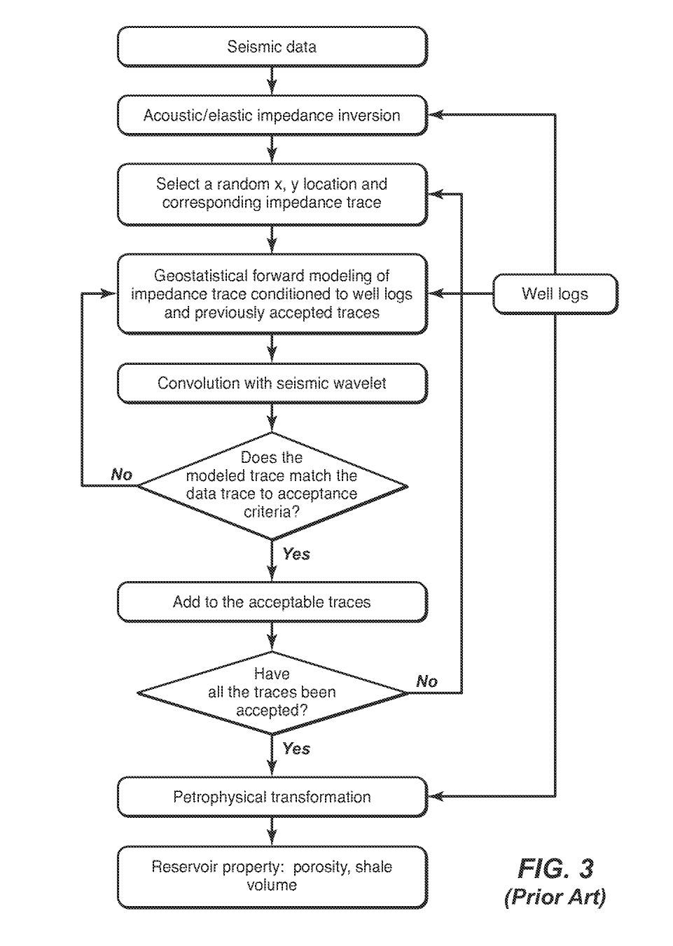

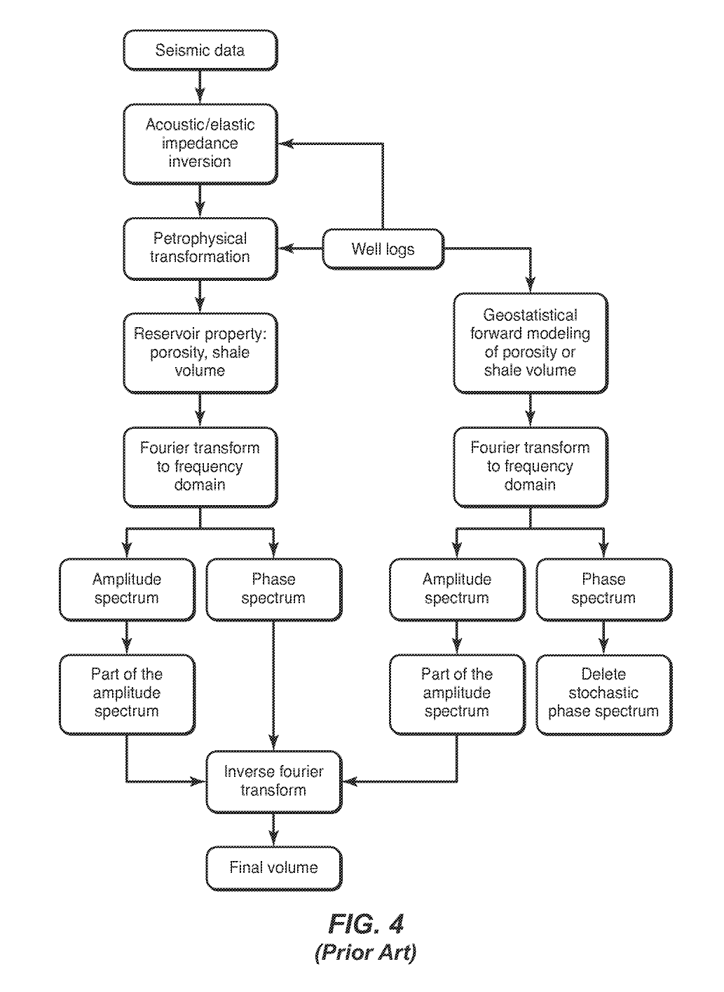

The invention will be described in connection with example embodiments. To the extent that the following description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims.

### DETAILED DESCRIPTION

Non-stationary multi-scale transforms use higher domain order (order>1) joint representations of data. Here, an example is given that uses a joint representation of “scale” and “space” to perform reservoir modeling activity, where “scale and “space” are domains. A geostatistical forward model is one example of a reservoir model. Reservoir models may also be created by surfaces forming an enclosed object(s) and populating the properties by processing local coordinate fields within the object(s) in order to match input statistics.

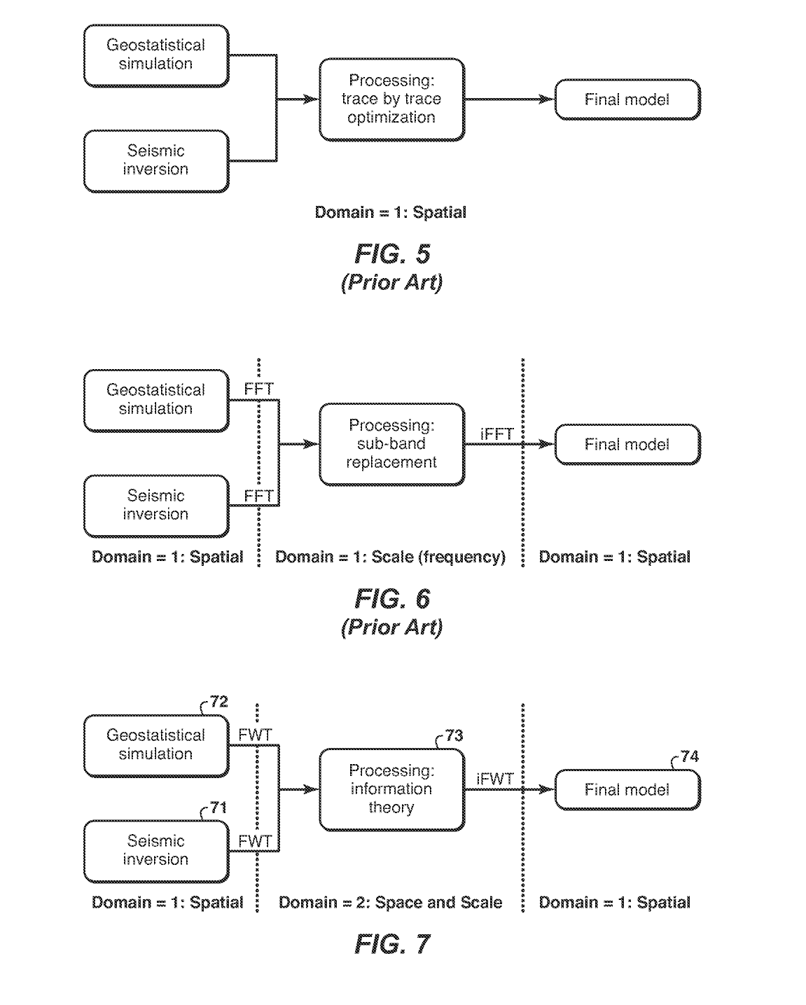

Bortoli (1993) uses a method that performs the processing in the space domain only, domain order=1 (FIG. 5). Calvert et al. (2001) covers the use of a representation that represents “scale” or “space”, one or the other but not both jointly; thus, domain order=1 (FIG. 6). In the Calvert publication, the Fourier transform is used to accomplish the representation and perform stationary reservoir modeling in the scale, i.e. frequency, domain. (Frequency is the scale when the measurement is time.) The Fourier transform decomposes a signal into a global summation of sine and cosine bases at certain frequencies. It relies on constructive and deconstructive interference of these globally specified frequencies to localize events in the signal. Thus, it has no direct local control on what is happening and where. The representation of the signal in this domain is therefore not sparse, but rather full, complicated, and cumbersome to use in spatial modeling.

The addition of the joint representation of both “scale” and “space” enables the modeler to handle not only scale dependency but also non-stationarity. Here, stationarity is referring to signals that happen globally in the model, whereas non-stationarity refers to locally varying spatial signals. If a multi-scale transform is non-stationary it allows the modeler to incorporate a given frequency of variation at a particular location in space, or in the model. The stationary methods allow only global specification of the frequency content.

The present invention uses this non-stationary, multi-scale representation to combine multiple data sources into one coherent reservoir model. Certain types of data are frequency band limited and thus the multi-scale nature of the transforms are utilized to honor them appropriately. Likewise, other data types are spatially localized, and thus the non-stationary nature of these transforms can be exploited to honor these data types. Additionally, this representation can be used to extract meaningful trends and patterns from a third co-located data source. This third set of data can be used in the processing responsible for the merging of the two primary data sources. Algorithms can also be expressed to operate in this non-stationary multi-scale representation of domains that combine many data types or create new data from the existing data.

The following non-exhaustive list contains some examples of non-stationary multi-scale transforms:

Wavelet transform (Debauchies 1992)

Ridgelets (Candes 1998)

Curvelet transform (Candes and Donoho 2004)

Second generation wavelets and Lifting schemes (Sweldens 1998)

All of these transforms may be generalized to N-dimensional analysis, and are typically used in 1, 2, 3, or 4 dimensions. A method for processing data with these representations can take the form of an equation, an algorithm or a heuristic.

After the reservoir modeling processing has been completed within this joint representation of domains the transform back is performed with the given transform inverse. This inverse transform yields the final reservoir model.

The present inventive method also includes the use of fast versions of these algorithms. The fast versions use computational methods to compute the equivalent results of the transforms with some efficient computational method. An example is the use of filter banks for the fast discrete wavelet transform. Likewise, the present invention also includes the use of a single scale version of the transform being used in reservoir modeling to accomplish the desired result.

Details on Processing Methods

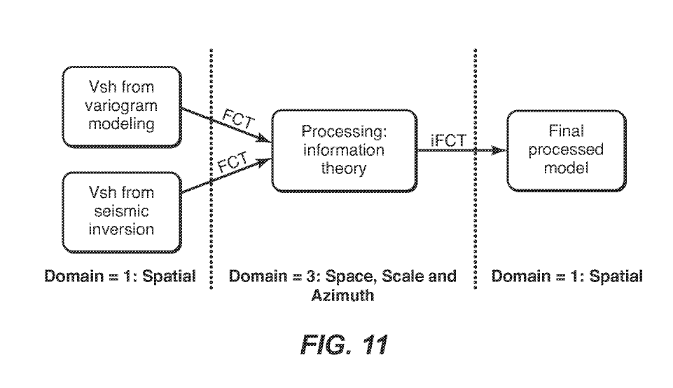

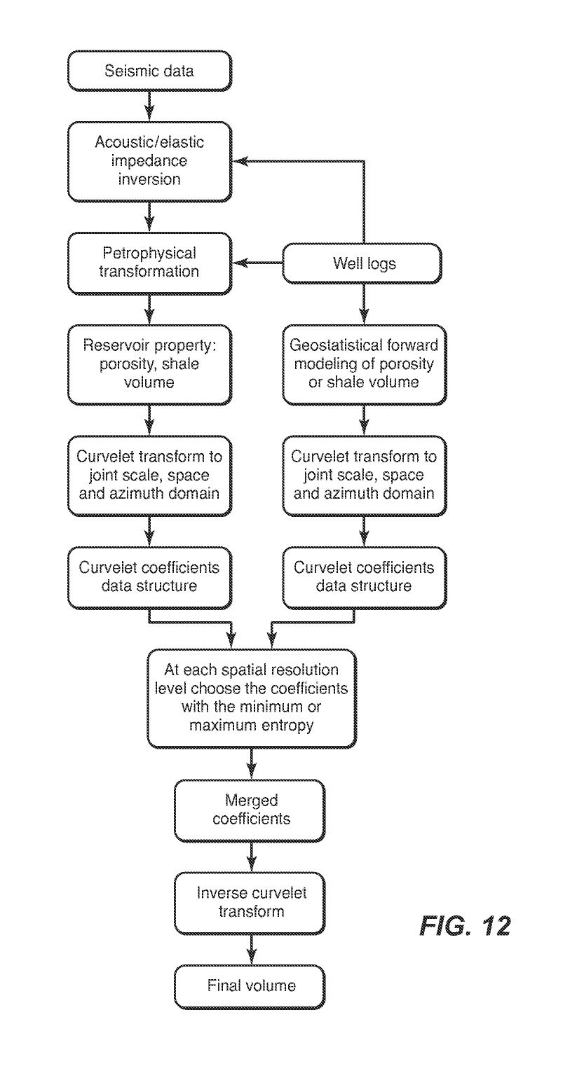

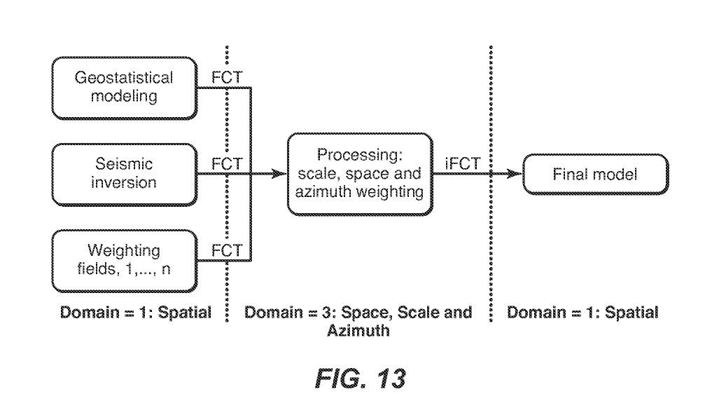

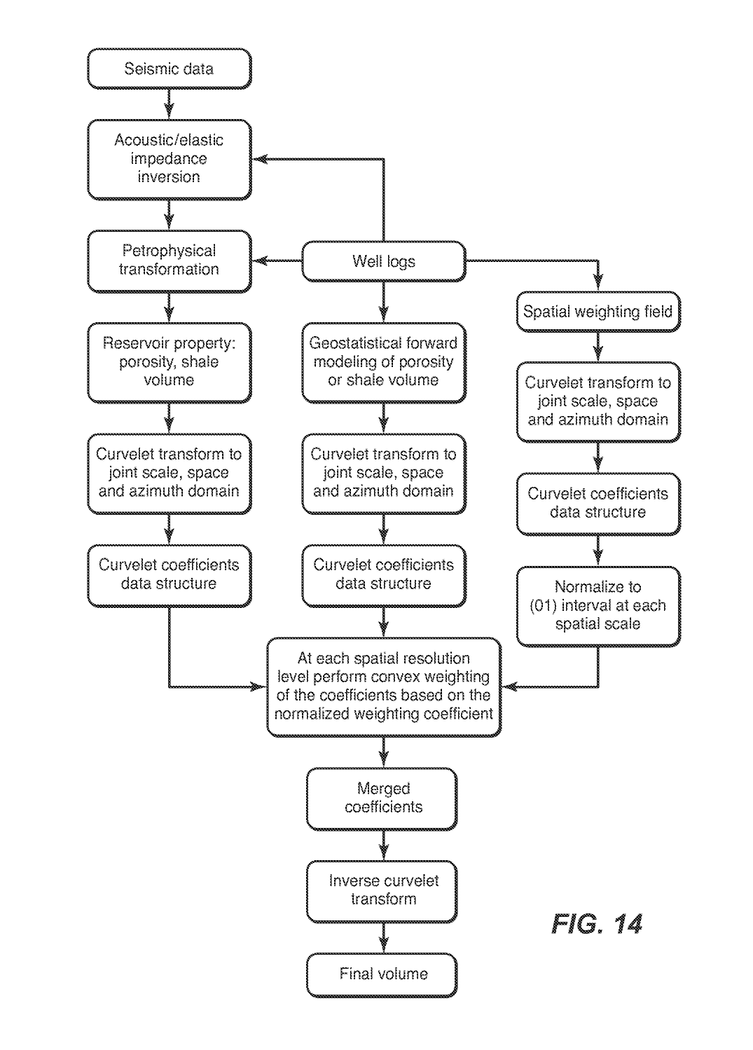

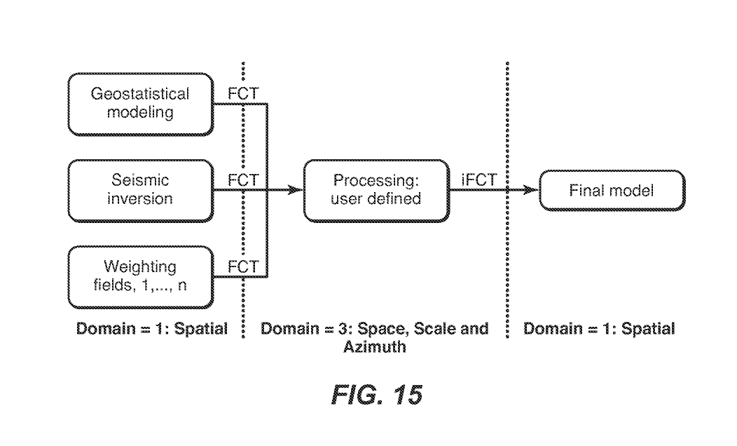

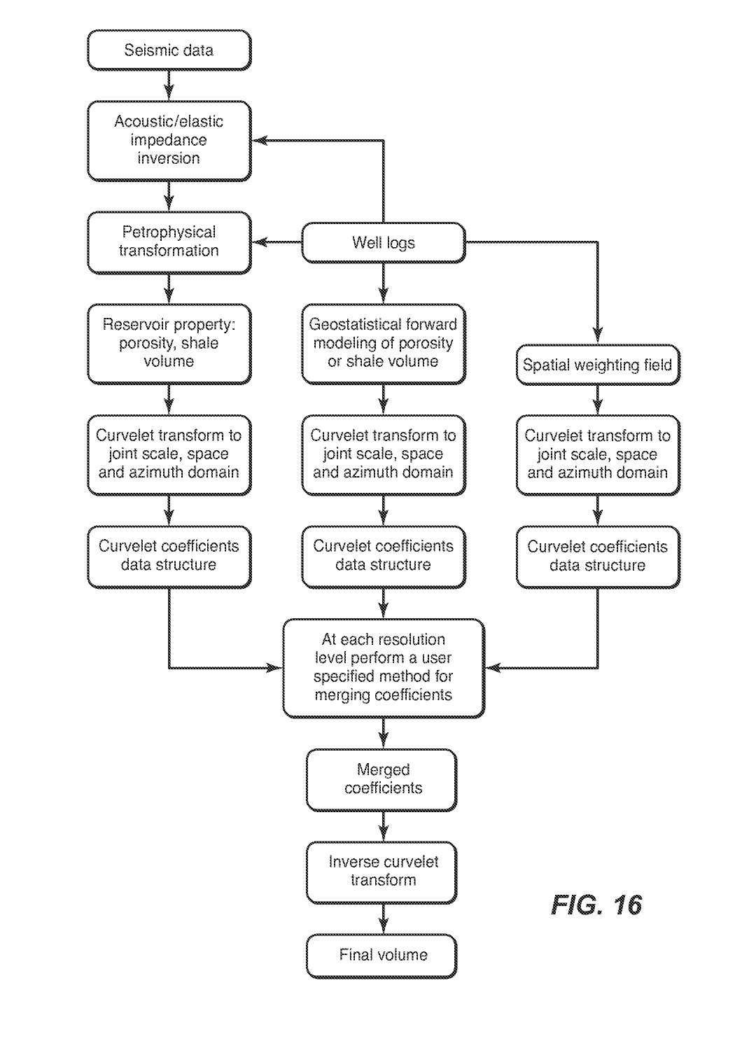

Any processing method in the joint representation space may be used. One example uses heuristics based on information theory to determine how to combine data within the transformed domain. A second example uses a convex combination with a weighting coefficient determined by a third input volume. Alternatively, any other user-defined method of processing may be used. Although the drawings discussed previously may indicate use of the Wavelet Transform (Debauchies 1992), the Curvelet Transform (Candes and Donoho 2004) or the Ridgelet Transform (Candes 1998) may be substituted. FIGS. 11-16 outline examples using the Curvelet Transform.

Heuristic Method

Information entropy can be defined as many types of entropy, for example the Shannon entropy:

H(X)=E[I(X)]=E[−1n(P(X))]=Σᵢ−P(xᵢ) log_{b}P(xᵢ) (1)

where i is the number of samples in X and b is a base of the logarithm. Common values of b include 2, Euler's number e, and 10.

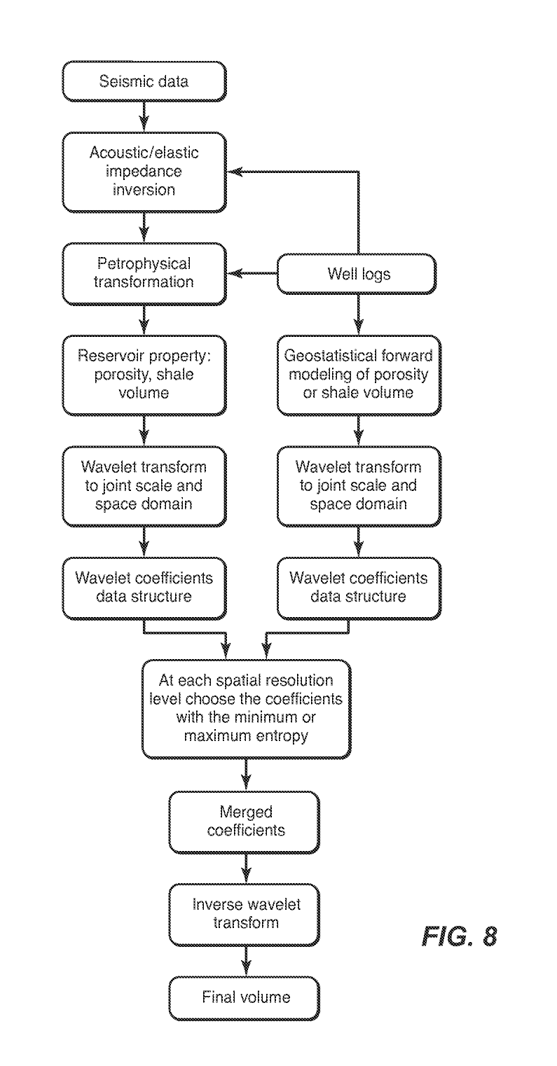

Entropy, as defined in (1), can be understood as a measure of disorder or uncertainty. It is used here at each resolution level to determine which data source within the joint representation space to choose at each discretization for the merged data output. A heuristic, such as “Choose the data source with the maximum entropy” or “Choose the data source with the minimum entropy” may be used to abstract the choosing to a quantitative logical operation. Examples of this are illustrated in FIGS. 7 and 8.

Convex Combination with Spatially Co-located Weighting Coefficients

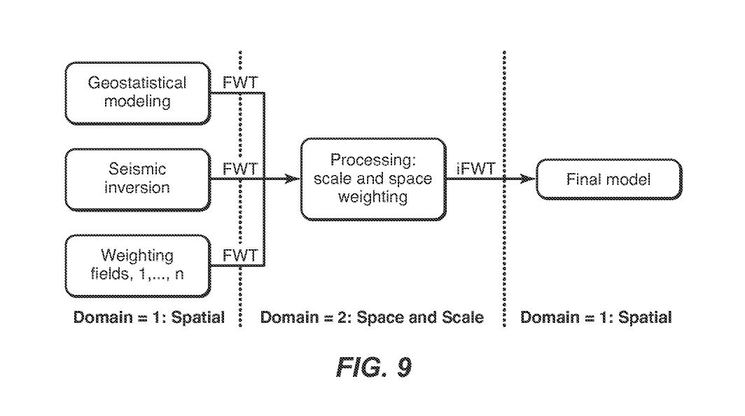

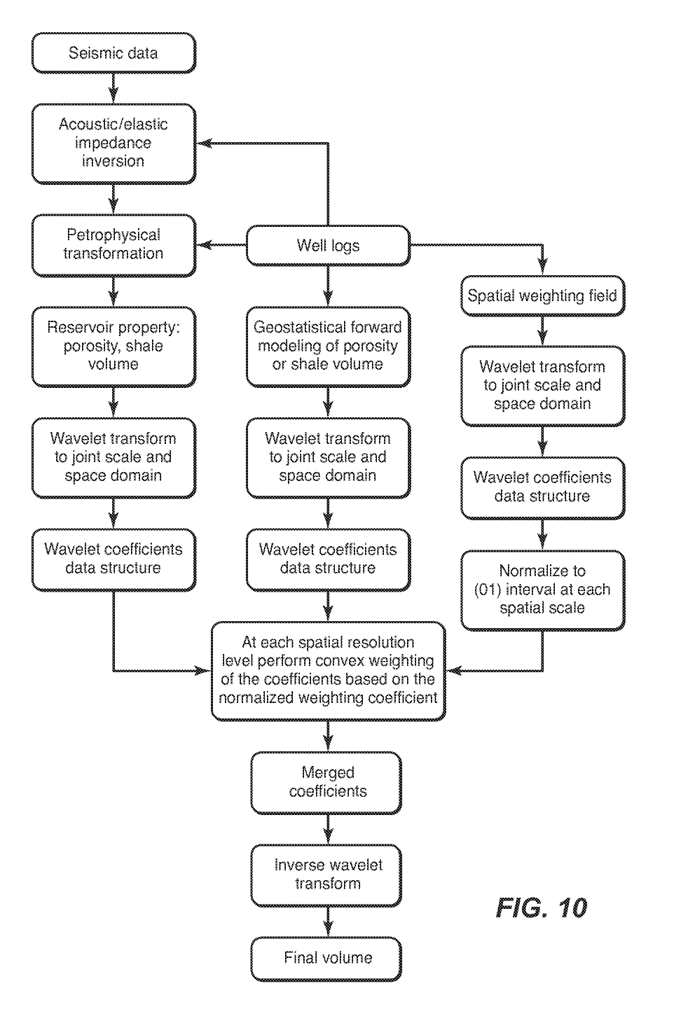

A third co-located data source may be used to indicate how to combine the two other primary data sources, the reservoir model (e.g., geostatistical model) and the seismic data. This data source may be transformed into the joint representation domain along with the two primary data sources as outlined in FIG. 9. It is used with the joint representation to provide a parameter α to a merging equation:

F=(1−∝)C_{Geostatistics}+C_{Seismic} (2)

Equation (2) is a convex combination of two data types; it can be extended to be applicable to any number of data types:

∝₁d₁+∝₂d₂+∝₃d₃+ . . . +∝ₙdₙ. (3)

The only requirement is that all the weighting coefficients sum to one:

∀∝ᵢ>0 and ∝₁+∝₂+∝₃+ . . . +∝ₙ−1 (4)

This equation is evaluated at every resolution level within the multi-resolution data structure created by the transform. Here, α may be based on any arbitrary collocated data, and when it is transformed into the joint representation space, the values are normalized to lie between zero and one for each resolution level.

The foregoing description is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined by the appended claims. All references cited in this document are incorporated herein by reference in those jurisdictions that allow it, to the extent they are not inconsistent with the disclosures herein.

### REFERENCES

Bortoli, L. J., Albert, F., Haas, A., Journel, A. G., “Constraining Stochastic Images to Seismic Data”, Geostatistics, Troia, Quantitative Geology and Geostatistics 1, 325-338 (1992).
Calvert , C. S., Bishop, G. W., Ma, Y. Z., Yao, T., Foreman, J. L., Sullivan, K. B., Dawson, D. C., Jones, T. A., U.S. Pat. No. 7,415,401 (2001).
Candes, E. J., Donoho, D. L., “New Tight Frames of Curvelets and Optimal Representations of Objects with C² Singularities,” Communications on Pure and Applied Mathematics 57, 219-266 (2004).
Connolly, P., “Elastic Impedance,” The Leading Edge 18, 438-452 (1999).
Donoho, D. L., Hou, X., “Beamlets and Multiscale Image Analysis,” Multiscale and Multiresolution Methods, Lecture Notes in Computational Science and Engineering 20, 149-196 (2002).
Haas, A., and O. Dubrule, “Geostatistical Inversion—A Sequential Method of Stochastic Reservoir Modeling Constrained by Seismic Data,” First Break 12, 561-569 (1994).
Isaaks, E. H. and Srivastava, R. M., Applied Geostatistics, Oxford University Press, New York, particularly pages 40-65 (1989).
Journel, A., “Geostatistics: Roadblocks and Challenges,” Geostatistics, Troia '92: Quanititative Geoglogy and Geostatistics 1, 213-224 (1992).
Mallat, S., A Wavelet Tour of Signal Processing, Academic Press, San Diego, particularly pages 80-91 (1999).
Strebelle, S., “Conditional simulations of complex geological structures using multiple-point statistics,” Mathematical Geology 34(1), 1-21 (2002).
Sweldens, W., “The Lifting Scheme: A Construction of Second Generation Wavelets,” SIAM Journal on Mathematical Analysis 29, 511-546 (1998).
Verly, G., “Sequential Gaussian Simulation: A Monte Carlo Approach for Generating Models of Porosity and Permeability,” Special Publication No. 3 of EAPG—Florence 1991 Conference, Ed.: Spencer, A.M (1991).
Whitcombe, D. N., Connolly, P. A., Reagan, R. L., Redshaw, T. C., “Extended elastic impedance for fluid and lithology prediction,” Geophysics 67, 63-67 (2002).
Yao, T., Calvert, C., Bishop, B. Jones. T., Ma, Y., Foreman, L., “Spectral Component Geologic Modeling: A New Technology for Integrating Seismic Information at the Correct Scale,” (book) Geostatistics Banff, 23-33; (journal) Quantitative Geology & Geostatistics 14 (2004); download: http://rd.springer.com/book/10.1007/978-1-4020-3610-1/page/1.
Zhang T., Switzer P., Journel A., “Filter-based classification of training image patterns for spatial Simulation,” Mathematical Geology 38, 63-80 (2006).

What is claimed is:

1. A method for integrating well log and seismic data into a single subsurface reservoir model, comprising:
(a) obtaining seismic data and well log data from a subsurface region;
(b) inverting the seismic data and applying a petrophysical transformation to generate a subsurface model of a reservoir property;
(c) generating a reservoir model of the reservoir property using the well log data;
(d) transforming the reservoir property model from inverting seismic data and the reservoir property model from reservoir modeling with well log data, to a joint domain, of order >1;
(e) processing the transformed models in the joint domain to coherently combine them into one reservoir model; and
(f) inverse transforming to obtain a reservoir model in space domain;
wherein (b)-(f) are performed using a computer.

2. The method of claim 1, wherein the transforming is performed using a non-stationary multi-scale transform.

3. The method of claim 2, wherein the non-stationary multi-scale transform is one of: a wavelet transform; a ridgelet transform; a curvelet transform; and second generation wavelets and lifting schemes.

4. The method of claim 1, wherein the processing is one of a heuristic method using information theory; a convex combination with spatially co-located weighting coefficients; and another processing method.

5. The method of claim 4, wherein the information theory method comprises minimizing or maximizing Shannon's entropy to determine which data source—seismic or well log—within the joint domain to choose at each cell in a discrete computational grid in order to generate a merged data output.

6. The method of claim 4, wherein the convex combination method further comprises:
obtaining a third co-located data source, being weighting fields to be used to indicate how to combine the reservoir model and the model derived from inverted seismic data;
transforming the weighting fields to the joint domain; and
using the weighting fields to combine the transformed models.

7. The method of claim 1, wherein the joint domain is of order 2, being space and scale;
the transform is a wavelet transform; and the processing is by a heuristic method using information theory.

8. The method of claim 1, wherein the joint domain is of order 2, being space and scale; the transform is a wavelet transform; and the processing uses convex combination with spatially co-located weighting coefficients.

9. The method of claim 1, wherein the joint domain is of order 3, being space, scale and azimuth; the transform is a curvelet transform; and the processing is by a heuristic method using information theory.

10. The method of claim 1, wherein the joint domain is of order 3, being space, scale and azimuth; the transform is a curvelet transform; and the processing uses convex combination with spatially co-located weighting coefficients.

11. The method of claim 1, wherein (d) and (e) comprise:
representing the inverted seismic model and the reservoir model each by a series expansion of basis functions and corresponding coefficients in the joint domain;
for each basis function, forming a single merged coefficient from two coefficients, which are the coefficient for the inverted seismic model and the coefficient for the geostatistical forward model;
wherein the combined reservoir model is represented by a series expansion of the basis functions with the merged coefficients.

12. The method of claim 11, wherein the processing is a heuristic method using information theory, and each merged coefficient is the coefficient, of the two coefficients, with minimum or maximum entropy.

13. The method of claim 11, wherein the processing is a convex combination with spatially co-located weighting coefficients, and each merged coefficient is determined by convex weighting of the two coefficients with the merged coefficients being normalized.
